(19) United States
(12) Patent Application Publication
(10) Pub. No.: US 2005/0090271 A1
(43) Pub. Date: Apr. 28, 2005

(54) Call routing configuration from a mobile terminal docking station

(75) Inventor: Dany Sylvain, Gatineau (CA)

Correspondence Address: WITHROW & TERRANOVA, P.L.L.C., P.O. BOX 1287, CARY, NC, 27512, US

(73) Assignee: NORTEL NETWORKS LIMITED, St. Laurent (CA)

(21) Appl. No.: 10/693,372

(22) Filed: Oct. 24, 2003

(51) Int. Cl. H04B 1/40; H04M 3/42; H04Q 7/20

(52) U.S. Cl. 455/461; 455/445; 455/417

(57) ABSTRACT

The present invention provides for a mobile terminal docking station, which is capable of providing docking and undocking signals to assist in routing incoming calls directed to a user associated with the mobile terminal and the docking station. The docking and undocking signaling may be messages sent directly to the entity providing call routing, as well as a special feature code or directory number, which is dialed to alert the wireline switch that the mobile terminal is in a docked or undocked state. Call routing logic is provided in a service node or a wireline switch supporting the docking station, and receives docking or undocking indicia directly from the docking station or indirectly via the wireline switch, and uses the indicia to determine how to route incoming calls to the user.

### FIELD OF THE INVENTION

The present invention relates to routing incoming calls, and in particular to providing information from a docking station for a mobile terminal to assist in the routing of the calls.

### BACKGROUND OF THE INVENTION

Today's telephony users are often associated with multiple telephones. As such, those trying to contact a telephony user will often need to make numerous calls. To minimize the guesswork associated with calling a telephony user, techniques are being developed to reroute calls originally intended for any one of the telephones associated with the telephony user to a specified telephone, based on routing criteria. The routing criteria may be configured by the telephony user and may take various factors into consideration in an effort to route the incoming calls to a most appropriate telephone, regardless of the telephone to which the call was originally directed.

Unfortunately, it has proven difficult to provide information indicative of the relative location of the telephony user to assist in selecting the telephone to which incoming calls should be directed. Given the portability of a telephony user's mobile terminal, attempts have been made to track the mobile terminal's location and determine how to route incoming calls based thereon, since the location of the mobile terminal is often indicative of the telephony user's actual location. Accordingly, there is a need for an approved technique for providing information bearing on a telephony user's location to assist in routing calls to an appropriate one of the telephony user's multiple telephones. There is a further need to provide such a technique without requiring special actions by the telephony user in an effort to make the information more reliable, since telephony users are prone to forgetting or avoiding taking extra steps in providing information bearing on their location to assist in the routing of incoming calls.

### SUMMARY OF THE INVENTION

The present invention provides for a mobile terminal docking station, which is capable of providing docking and undocking signals to assist in routing incoming calls directed to a user associated with the mobile terminal and the docking station. The docking and undocking signals may be messages sent directly to the entity providing call routing, as well as a special feature code or directory number, which is dialed to alert a wireline switch that the mobile terminal is in a docked or undocked state. Call routing logic is provided in a service node or the wireline switch supporting the docking station, and receives docking or undocking indicia directly from the docking station or indirectly via the wireline switch, and uses the indicia to determine how to route incoming calls to the user. When the docking station is supported by the wireline switch, other wireline terminals may be connected to the docking station or to the telephony line coupling the docking station to the wireline switch. The docking station can detect the relative proximity of the mobile terminal through a physical connection or through wireless communication techniques. Preferably, the docking station is capable of recharging a battery in the mobile terminal when docked. In other embodiments, wireline-based communications may be effected with the mobile terminal through the docking station. The call routing logic may incorporate other routing criteria, in addition to the docking state of the mobile terminal, to determine how incoming calls are ultimately routed.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of a communication environment according to one embodiment of the present invention.

FIG. 2 is a communication flow diagram wherein a mobile terminal is associated with a docking station according to one embodiment of the present invention.

FIG. 3 is a communication flow diagram wherein a mobile terminal is not associated with the docking station according to one embodiment of the present invention.

FIG. 4 is a block representation of a docking station according to one embodiment of the present invention.

FIG. 5 is a block representation of a service node according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

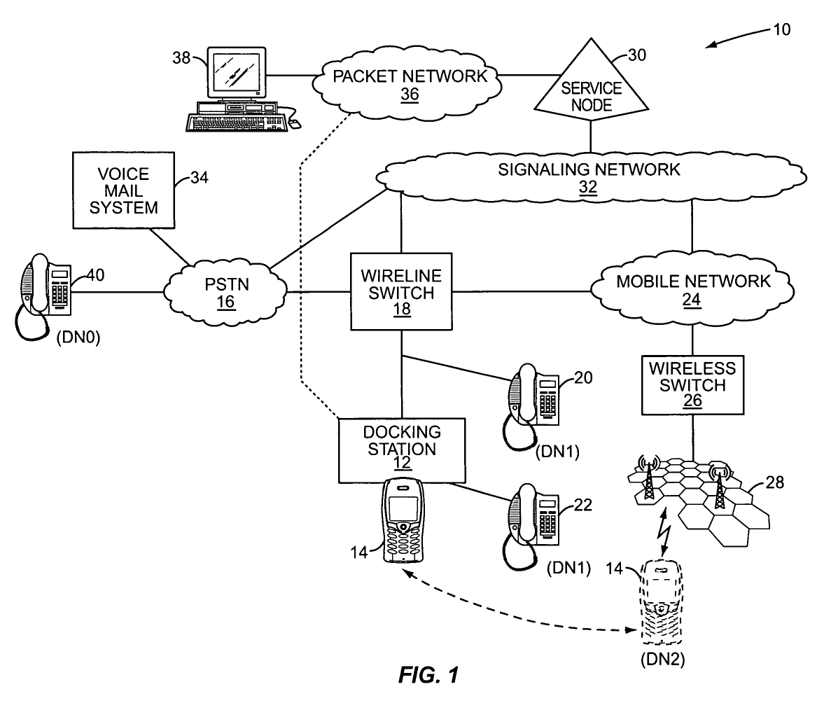

With reference to FIG. 1, a communication environment 10 is illustrated with a docking station 12, which is capable of supporting a mobile terminal 14, as well as facilitating communications over the Public Switched Telephone Network (PSTN) 16 via a wireline switch 18. The docking station 12 is coupled to the wireline switch 18 via a telephony line. A first wireline terminal 20 may also be coupled to the telephony line directly, wherein a second wireline terminal 22 may be indirectly coupled to the telephony line via the docking station 12. Depending on the configuration of the docking station 12, the mobile terminal 14 may be configured to facilitate communications over the telephony line, in addition to being able to communicate over a mobile network 24 using traditional cellular communication techniques. For cellular communications, a wireless switch 26 associated with the mobile network 24 will cooperate with a cellular network of base stations 28 to facilitate wireless communications with the mobile terminal 14.

In a residential or business environment, a telephony user may be associated with multiple telephony terminals, such as the mobile terminal 14, wireline terminal 20, and wireline terminal 22. In the illustrated example, mobile terminal 14 is associated with a cellular directory number, DN2, wireline terminal 20 and 22 is associated with the telephony line with a directory number DN1. If the mobile terminal 14 is configured to facilitate communications over the telephony line, then it is also associated to the telephony line and directory number DN1. In an effort to have incoming calls that are originally intended for any of these telephony terminals rerouted to the telephony terminal desired by the telephony user, a service node 30 is provided to cooperate with the wireline switch 18 and, optionally, the wireless switch 26 to reroute the incoming calls to the desired telephony terminal of the telephony user. The service node 30 may be a separate entity interacting with the wireline switch 18 or the wireless switch 26 via a signaling network 32, or may be logically implemented in the wireline switch 18.

In operation, the service node 30 (or the logical implementation thereof) will receive an indication from either the wireline switch 18 or the wireless switch 26 that an incoming call is being directed to one of the telephony user's telephony terminals: mobile terminal 14 or wireline terminal 20, 22. Based on the routing criteria, the service node 30 will provide information to the wireline switch 18 or the wireless switch 26 from which the indication was received to either continue with establishment of the call as originally intended or reroute the call to another telephony terminal. Further, the mobile terminal 14, when configured to facilitate communications via the wireline switch 18 when associated with the docking station 12, may have multiple directory numbers either permanently or temporarily associated with it, such that incoming calls may be directed to the mobile terminal 14 through the wireline switch 18 or the wireless switch 26, as desired by the telephony user. Further detail regarding such routing is provided in co-assigned U.S. patent application Ser. No. 10/626,677 filed Jul. 24, 2003; U.S. patent application Ser. No. ______ filed Oct. 24, 2003 entitled CALL TRANSFER FOR AN INTEGRATED WIRELINE AND WIRELESS SERVICE USING A TEMPORARY DIRECTORY NUMBER; and U.S. patent application Ser. No. ______ filed Oct. 24, 2003 entitled CALL TRANSFER FOR AN INTEGRATED WIRELINE AND WIRELESS SERVICE USING A TEMPORARY DIRECTORY NUMBER, the disclosures of which are incorporated by reference herein in their entireties.

Regardless of whether calls can be directed to the mobile terminal 14 via the docking station 12, the service node 30 is alerted to incoming calls intended for a telephony terminal associated with a group of telephony terminals. Based on the routing criteria, the incoming call is either routed to the originally intended telephony terminal or another one of the telephony terminals in the group. Further, the incoming call could be routed to an alternative network to the originally intended telephony terminal, as described in the applications previously incorporated by reference. In general, the routing of the incoming call, whether as intended or rerouted based on the routing criteria, is determined based on a directory number or like telephony address, such as a Uniform Resource Locator (URL) in a packet-based environment. In addition to routing calls to other directory numbers, incoming calls may be routed to an appropriate voicemail system 34, if so desired by the telephony user.

As noted, the service node 30 is alerted of incoming calls, and controls routing of the incoming calls based on routing criteria associated with the intended telephony terminal or directory number. Since the telephony user is constantly on the move, providing up-to-date information as to the relative location of the mobile terminal 14 to the service node 30 is a challenge. The present invention relies on the location of the mobile terminal 14 to assist in controlling the routing of incoming calls to the telephony user. In particular, the docking station 12 is configured to detect when the mobile terminal 14 is proximate thereto, by detecting the ability to establish a wireless communication with the mobile terminal 14 or detecting its physical presence in a cradle associated with the docking station 12. Since the docking station 12 is connected to the wireline switch 18 either directly or indirectly via a telephony line, the docking station 12 will take action resulting in the service node 30 detecting that the mobile terminal 14 is proximate to the docking station 12.

When the mobile terminal 14 is proximate to the docking station 12, the service node 30 can reroute incoming calls originally intended for the mobile terminal 14 via the wireless network through directory number DN2, to directory numbers DN1, which are associated with wireline terminals 20 and 22, respectively. If an incoming call can be directed to the mobile terminal 14 via the docking station 12, the service node 30 may take that action as well, depending on how the routing criteria are configured. Further, incoming calls to the telephony user when the mobile terminal 14 is proximate to the docking station 12 may result in any of the telephony user's telephony terminals ringing in parallel, or sequentially if the previously rung telephony terminal is not answered. The routing criteria may also route the incoming call to the voicemail system 34 for the telephony user if one or more of the telephony terminals goes unanswered. Again, the routing of the incoming call to the voicemail system 34 will depend on how the routing criteria are configured. When the mobile terminal 14 is not proximate to the docking station 12, the service node 30 can reroute incoming calls originally intended for telephony terminal 20 at DN1 to an alternate endpoint, such as mobile terminal 14, via the wireless network through directory number DN2.

The service node 30 may receive indication that the mobile terminal 14 is proximate to the docking station 12 through numerous techniques. A first technique relies on the docking station 12 sending a proximity signal to the wireline switch 18 via the telephony line. The proximity signal provided to the wireline switch 18 may take many forms. For example, the docking station 12 may be configured to dial a special feature code or a certain directory number when the mobile terminal 14 comes within a certain proximity of the docking station 12 or leaves a certain proximity thereof. Different special feature codes and directory numbers may be used to indicate entering the proximity of the docking station 12 and leaving the proximity thereof. Alternatively, repeated receipt of a certain special feature code or directory number may effectively toggle between the mobile terminal 14 being proximate to (docked) or not proximate to (undocked) the docking station 12. In a packet environment, the wireline switch 18 may be replaced with a telephony server, and as such, the proximity signal may be received via H.323, the Session Initiation Protocol (SIP), or other packet-based communication protocol. Communications between the wireline switch 18 or telephony server and the service node 30 may rely on Intelligent Network (IN) protocols, SIP, Computer Telephony Interface (CTI) protocols, and the like.

Upon receiving the proximity signal, the wireline switch 18 will send an appropriate message to the service node 30 indicating the mobile terminal 14 is proximate to the docking station 12. Alternatively, the docking station 12 may have access to a packet network 36, such as the Internet, through which information indicative of the mobile terminal 14 being proximate to the docking station 12 may be provided directly to the service node 30, without the need of being relayed through the wireline switch 18. Thus, the docking station 12 provides a docking alert when the mobile terminal 14 is proximate to the docking station 12. The docking alert will directly or indirectly result in the service node 30 recognizing the proximity of the mobile terminal 14 to the docking station 12. The service node 30 will recognize this condition and route incoming calls based thereon in light of the routing criteria. A similar alert is provided when the mobile terminal 14 is no longer proximate to the docking station 12 and will result in the service node 30 routing incoming calls according to the routing criteria based on the mobile terminal 14 not being proximate to the docking station 12. The reception of the docking alert by the wireline switch 18 or the service node 30 may be confirmed back to the docking station 12 via special in-band tones, DTMF or messages via the packet network 36.

The routing criteria are preferably readily configurable by the telephony user, a representative thereof, or a service provider. Such configuration may take place via the packet network 36 using a computing client 38, such as a personal computer, personal digital assistant, or other computing device. Alternatively, routing criteria may be established via a telephony terminal through various types of signaling or via an interactive voice response system (not shown).

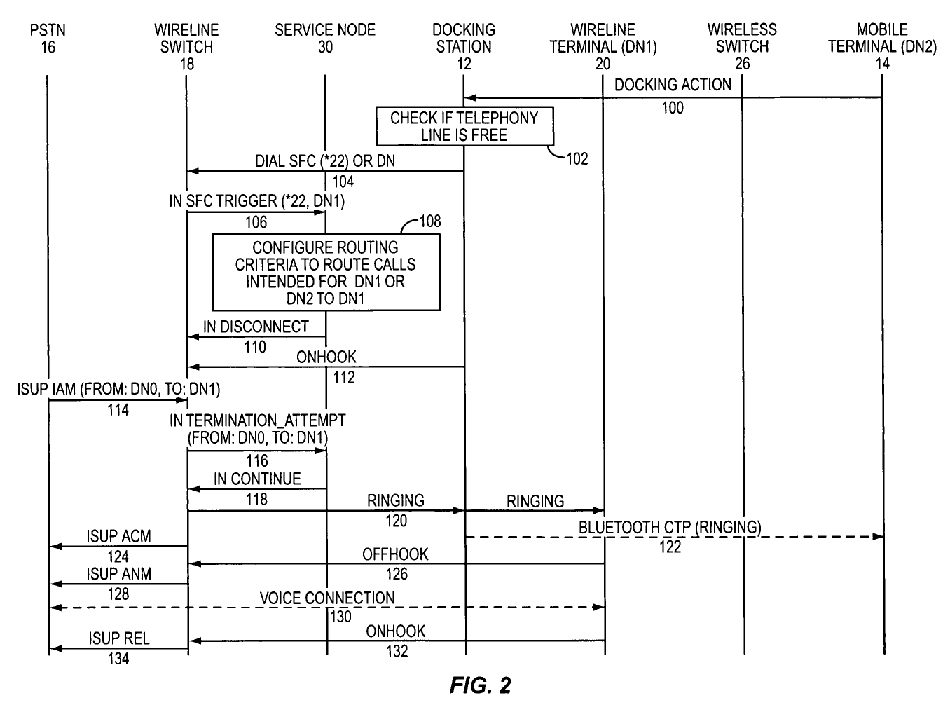

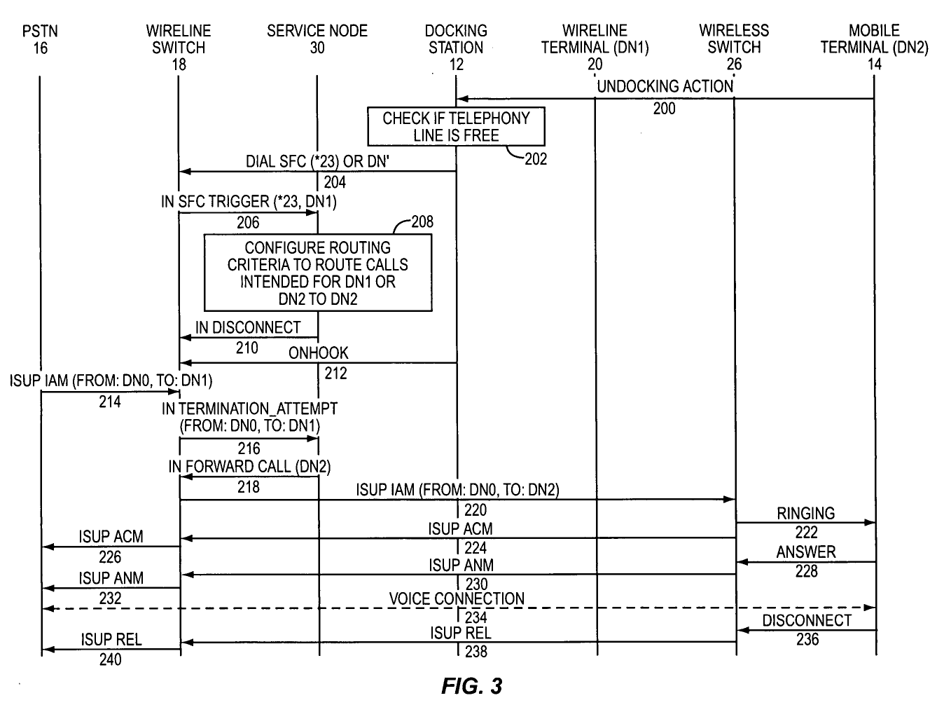

A remote terminal 40 is also illustrated in FIG. 1 and is associated with directory number DN0. For the communication flows of FIGS. 2 and 3, assume an incoming call to one of the telephony terminals associated with the telephony user is initiated from the remote terminal 40 through the PSTN 16. With particular reference to FIG. 2, an exemplary communication flow is provided to illustrate a docking action, wherein the mobile terminal 14 comes into proximity of the docking station 12, the service node 30 is alerted to the docking action, and a subsequent incoming call intended for wireline terminal 20 is allowed to continue. In this scenario, the routing criteria allow incoming calls to any of the wireline terminal 20, wireline terminal 22, or mobile terminal 14 to be routed or rerouted to wireline terminal 20 when the mobile terminal 14 is docked with the docking station 12. When the mobile terminal 14 is not docked with the docking station 12, assume that all incoming calls to these telephony terminals are routed to the mobile terminal 14. Further assume that the mobile terminal 14 is docked with the docking station 12 when the mobile terminal 14 is placed in a cradle associated with the docking station 12 or comes within a local wireless communication range of the docking station 12.

Initially, the service node 30 knows that the mobile terminal 14 is not docked with the docking station 12, and that incoming calls to directory numbers DN1 (wireline terminal 20, 22) or DN2 (mobile terminal 14) should be routed to mobile terminal 14 using directory number DN2. When the mobile terminal 14 is docked (step 100), the docking station 12 will check to see if the telephony line to the wireline switch 18 is free (step 102). If and when the telephony line is free or otherwise available, the docking station 12 will automatically dial a special feature code (SFC) or a special directory number, which is received by the wireline switch 18. In this example, assume that a special feature code, *22, is dialed (step 104). As such, the wireline switch 18 will recognize the special feature code as that corresponding to the mobile terminal 14 being docked with the docking station 12, and will initiate an IN SFC Trigger message to the service node 30 (step 106). The message sent to the service node 30 will preferably identify the special feature code and the directory number associated with the telephony line servicing the docking station 12. In this case, the directory number is DN1. Upon receipt of the message, the service node 30 will configure the routing criteria to route calls intended for DN1 or DN2 to directory number DN1, which is associated with the telephony line servicing the docking station 12 as well as wireline terminal 20, 22 (step 108). The service node 30 will also send an IN Disconnect message to the wireline switch 18 to end the connection with the docking station 12 through which the special feature code was received (step 110). The docking station 12 will then go onhook (step 112).

At this point, the routing criteria at the service node 30 are properly configured for when the mobile terminal 14 is docked in the docking station 12. When an incoming call is received from the remote terminal 40 via the PSTN 16, the wireline switch 18 will receive an Integrated Service User Part (ISUP) Initial Address Message (IAM) identifying an incoming call being received from directory number DN0 and intended for directory number DN1 (step 114). The wireline switch 18 is provisioned to recognize that call routing instructions for directory number DN1 must be received from the service node 30, and as such, the wireline switch 18 will send an IN Termination Attempt trigger message to the service node 30 identifying the caller and called party directory numbers DN0 and DN1, respectively (step 116). The service node 30 will access the routing criteria associated with directory number DN1, and determine how to route the incoming call. In this example, since the mobile terminal 14 is docked with the docking station 12, the routing criteria dictate that the incoming call be routed to directory number DN1. As such, the service node 30 will instruct the wireline switch 18 to continue with the call in a normal fashion by sending an IN Continue message (step 118). The wireline switch 18 will respond by initiating a Ringing signal over the telephony line (step 120). By providing the Ringing signal over the telephony line, the docking station 12 and at least wireline terminal 20 will receive the Ringing signal. Optionally, the docking station 12 may initiate ringing of the mobile terminal 14 through a physical or local wireless (as shown) communication interface (step 122). The local wireless communication interface may be provided via a Bluetooth interface using the Cordless Telephony Profile (CTP).

In the meantime, the wireline switch 18 will send an ISUP Address Complete Message (ACM) back through the PSTN 16 to alert the telephony switch supporting the remote terminal 40 that the call is continuing (step 124). When wireline terminal 20 is answered, the wireline switch 18 will receive an Offhook signal (step 126), and send an ISUP Answer Message (ANM) through the PSTN 16 to the telephony switch supporting the remote terminal 40 (step 128). At this point, a voice connection is established between wireline terminal 20 and the remote terminal 40 via the PSTN 16 (step 130). When the telephony user ends the call, the wireline switch 18 will detect the wireline terminal 20 going onhook (step 132) and send an ISUP Release (REL) message to the telephony switch supporting the remote terminal 40 via the PSTN 16 (step 134). In addition to the wireline switch 18 providing information to the service node 30, an alternative would be to provide an appropriate message directly from the docking station 12 via the packet network 36.

Turning now to FIG. 3, the communication flow effectively continues, wherein the mobile terminal 14 is taken away from the docking station 12 (undocking action). The routing criteria at the service node 30 are updated, and a subsequent call intended for directory number DN1 is rerouted to the mobile terminal 14 using directory number DN2. Initially, the docking station 12 detects an undocking action (step 200), which indicates that the mobile terminal 14 has been pulled from an associated cradle, or a local wireless communication link is broken or no longer available. As such, the docking station 12 will check if the telephony line is free (step 202). If and when the telephony line is free or otherwise available, the docking station 12 will dial a second special feature code (*23) or directory number DN′ (step 204). In this embodiment, assume the wireline switch 18 is responsive to the special feature code instead of a special directory number. As such, when the special feature code is received, the wireline switch 18 will send an IN SFC Trigger to the service node 30 identifying the special feature code (*23) and the directory number associated with the special feature code, DN1 (step 206). The service node 30 will recognize the special feature code (*23) as one indicative of an undocking action, and will therefore configure the routing criteria associated with directory number DN1 to route calls intended for directory numbers DN1 or DN2 to directory number DN2 (mobile terminal 14) (step 208). The service node 30 will then send an IN Disconnect message to the wireline switch 18 to effectively disconnect the special feature code session (step 210), and the docking station 12 will go onhook (step 212).

Next, assume that an incoming call is initiated from the remote terminal 40 to wireline terminal 20 using directory number DN1. As such, the wireline switch 18 will receive an ISUP IAM indicating that a call is being attempted from directory number DN0 to directory number DN1 (step 214). The wireline switch 18 will recognize that routing instructions for calls to directory number DN1 must be received from the service node 30, and as such will initiate an IN Termination Attempt trigger to the service node 30 indicating an incoming call is being attempted from directory number DN0 to directory number DN1 (step 216). The service node 30 will access the routing criteria associated with directory number DN1 and recognize that incoming calls should be directed to directory number DN2. The service node 30 will provide instructions to the wireline switch 18 to forward or otherwise reroute the incoming call to directory number DN2 using an IN Forward Call message identifying directory number DN2 (step 218).

The wireline switch 18 will respond by forwarding the incoming call to directory number DN2, such as by sending an ISUP IAM toward the wireless switch 26 (step 220). The ISUP IAM will indicate that an incoming call is being initiated from directory number DN0 and is to be completed to directory number DN2. The wireless switch 26 will respond by initiating ringing of the mobile terminal 14 (step 222), as well as respond to the wireline switch 18 with an ISUP ACM (step 224). The wireline switch 18 will forward the ISUP ACM back through the PSTN 16 to the telephony switch supporting the remote terminal 40 (step 226). When the mobile terminal 14 is answered (step 228), the wireless switch 26 will send an ISUP ANM to the wireline switch 18 (step 230), which will forward the ISUP ANM through the PSTN 16 to the telephony switch supporting the remote terminal 40 (step 232). At this point, a voice connection is established between the mobile terminal 14 and the remote terminal 40 (step 234). If the call is ended at the mobile terminal 14, the wireless switch 26 will receive a Disconnect message (step 236) and send an ISUP REL message to the wireline switch 18 (step 238), which will forward the ISUP REL message through the PSTN 16 to the telephony switch supporting the remote terminal 40 (step 240).

From the above, the present invention provides a docking station 12 capable of automatically effecting an update of a service node 30, such that incoming calls to one or more telephony terminals associated with a telephony user or an affiliated group are routed to the appropriate telephony terminal or routed to one telephony terminal through an appropriate network. For the latter case, the mobile terminal 14 may be affiliated with a mobile directory number, which is permanent or temporary, as well as a wireline directory number, wherein calls associated with the wireline directory number are facilitate via the docking station 12 using the mobile terminal 14. In this situation, the service node 30 may route an incoming call intended for the mobile terminal 14 through the wireless switch 26 when the mobile terminal 14 is not docked with the docking station 12, and through the wireline switch 18 when the mobile terminal 14 is docked with the docking station 12.

In addition to simply routing calls based on whether or not the mobile terminal 14 is docked with the docking station 12, additional rules for routing the call may be applied to call routing in combination with the docking status. Thus, the docking criteria may take into consideration the originally intended directory number, the calling party, the time of day, the date, or any other criteria deemed helpful in routing calls to a telephony user's telephony terminals.

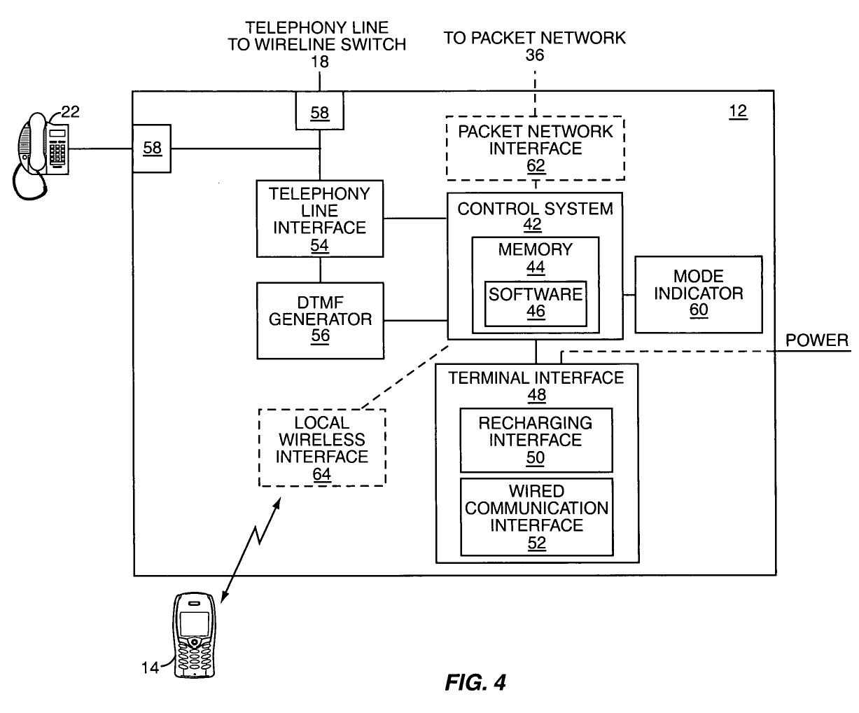

Turning now to FIG. 4, a block representation of a docking station 12 is provided according to one embodiment of the present invention. The docking station 12 will include a control system 42 having memory 44 with sufficient software 46 to provide the above functionality, as well as control associated interfaces and systems. The interfaces will typically include a terminal interface 48, recharging interface 50, wired communication interface 52, and telephony line interface 54. In one embodiment, the terminal interface 48 acts as a physical cradle or like docking interface, which is closely associated with the recharging interface 50 and the wired communication interface 52. The recharging interface 50 will connect with the mobile terminal 14 to supply power to the mobile terminal 14 for operation and recharging of batteries. The wired communication interface 52 may connect with the mobile terminal 14 in a fashion allowing bidirectional communications with the telephony line interface 54 such that calls may be established with the mobile terminal 14 via the docking station 12. The telephony line interface 54 is configured to provide an interface with the wireline switch 18 via the telephony line.

The docking station 12 may take on various configurations having varying levels of functionality. For example, a basic configuration would only function to provide alerts associated with docking or undocking actions, while more sophisticated configurations would allow recharging of the mobile terminal 14 or communications with the mobile terminal 14. When alerts are provided via the telephony line interface 54, the docking station 12 will include a dual tone multi-frequency (DTMF) generator 56 associated with the telephony line interface 54 and under the control of the control system 42. In operation, the control system 42 will automatically trigger the DTMF generator 56 to dial the special feature codes or special directory numbers, as well as control the telephony line interface 54 to determine whether the line is available and go offhook and onhook to allow dialing of the special feature codes or special directory numbers to provide the docking and undocking action alerts. The telephony line interface 54 will physically connect to the telephony line and any other associated telephony terminals, such as wireline terminal 22, through appropriate connectors 58.

To provide feedback to the telephony user as to the status of the docking station 12, and more particularly to whether or not the docking station 12 has provided an alert indicative of docking status, a mode indicator 60 is provided. The mode indicator 60 may be a simple LED or display with an appropriate readout indicating that the mobile terminal 12 is docked or undocked. The docking station 12 can optionally include a packet network interface 62 for facilitating communications over the packet network 36 to any number of devices, including the service node 30. As noted above, docking status alerts may be provided to the service node 30 via the packet network 36 in an effort to avoid requiring the wireline switch 18 to relay the alert to the service node 30. Further, the docking station 12 may include a local wireless interface 64, such as a Bluetooth interface, to facilitate wireless communications with the mobile terminal 14 when the mobile terminal 14 is within relatively close proximity to the docking station 12. The local wireless interface 64 can be used to simply detect the presence of the mobile terminal 14, as well as to facilitate bidirectional communications with the mobile terminal 14 to facilitate a call via the docking station 12.

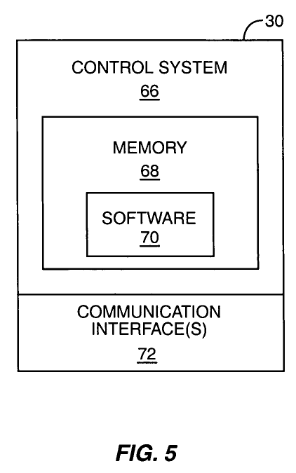

With reference to FIG. 5, a block representation of a service node 30 is illustrated as having a control system 66 with sufficient memory 68 for storing the software 70 required to operate the service node 30 as described above. The control system 66 is also associated with one or more communication interfaces 72 to facilitate communications with the wireline switch 18 or the docking station 12 directly via the packet network 36. The communication interface 72 may also be used to provide a web interface to allow the telephony user to configure the routing criteria.

Those skilled in the art will recognize improvements and modifications to the preferred embodiments of the present invention. All such improvements and modifications are considered within the scope of the concepts disclosed herein and the claims that follow.

1. A docking station for a mobile terminal comprising:
a) a signaling interface;
b) a mobile terminal interface adapted to detect when the mobile terminal is proximate to the docking station; and
c) a control system associated with the signaling interface and the mobile terminal interface and adapted to:
i) send a first signal via the signaling interface when the mobile terminal becomes proximate to the docking station; and
ii) send a second signal via the signaling interface when the mobile terminal is no longer proximate to the docking station, the first and second signals being used to determine how incoming calls intended for a user associated with the mobile terminal and the docking station are routed.

2. The docking station of claim 1 wherein the signaling interface is a wireline telephony interface adapted to interact with a wireline switch.

3. The docking station of claim 2 further comprising a dual tone multi-frequency generator associated with the wireline telephony interface and the control system, and adapted to generate the first and second signals as a series of dialed digits.

4. The docking station of claim 3 wherein the first and second signals are special feature codes.

5. The docking station of claim 3 wherein the first and second signals are directory numbers.

6. The docking station of claim 2 further comprising a wireline terminal interface for connecting to a wireline terminal, the wireline terminal interface coupled to the telephony line interface.

7. The docking station of claim 1 wherein the signaling interface is a packet-based interface adapted to interact with a service node over a packet network, the service node providing call routing instructions to the wireline switch.

8. The docking station of claim 1 wherein the first and second signals are unique.

9. The docking station of claim 1 wherein the first and second signals are identical.

10. The docking station of claim 1 wherein the mobile terminal interface comprises a recharging interface for recharging a battery of the mobile terminal when the mobile terminal is proximate to the docking station.

11. The docking station of claim 1 wherein the mobile terminal interface comprises a communication interface adapted to communicate with the mobile terminal.

12. The docking station of claim 11 wherein the communication interface and the control system cooperate to facilitate calls with the mobile terminal via the signaling interface.

13. The docking station of claim 11 wherein the communication interface makes a physical connection to the mobile terminal.

14. The docking station of claim 11 wherein the communication interface is adapted to facilitate local wireless communications with the mobile terminal.

15. The docking station of claim 1 further comprising an indicator associated with the control system and adapted to alert the user when the mobile terminal is proximate to the docking station.

16. A method comprising:
a) sending a first signal via a signaling interface when a mobile terminal becomes proximate to a docking station; and
b) sending a second signal via the signaling interface when the mobile terminal is no longer proximate to the docking station, the first and second signals being used to determine how incoming calls intended for a user associated with the mobile terminal and the docking station are routed.

17. The method of claim 16 wherein the signaling interface is a wireline telephony interface adapted to interact with a wireline switch.

18. The method of claim 16 wherein the first and second signals as a series of dialed digits sent to a wireline switch.

19. The method of claim 18 wherein the first and second signals are special feature codes.

20. The method of claim 18 wherein the first and second signals are directory numbers.

21. The method of claim 16 wherein the first and second signals are sent to a service node over a packet network, the service node providing call routing instructions to a wireline switch, which is connected to the docking station.

22. The method of claim 16 wherein the first and second signals are unique.

23. The method of claim 16 wherein the first and second signals are identical.

24. The method of claim 16 further comprising recharging a battery of the mobile terminal when the mobile terminal is proximate to the docking station.

25. The method of claim 16 further comprising communicating with the mobile terminal via the docking station.

26. The method of claim 25 further comprising facilitating calls with the mobile terminal via the signaling interface.

27. The method of claim 16 further comprising providing an indicator to alert the user when the mobile terminal is proximate to the docking station.

28. A method for routing calls to a most appropriate telephony terminal of a user comprising:
a) receiving docking indicia indicative of a mobile terminal being proximate to a docking station;
b) receiving undocking indicia indicative of the mobile terminal not being proximate to the docking station;
c) receiving incoming call indicia indicative of an incoming call intended for at least one telephony terminal associated with the user, the at least one telephony terminal including the mobile terminal; and
d) determining how to route the incoming call based on the docking or undocking indicia.

29. The method of claim 28 further comprising effecting routing of the incoming call, wherein the incoming call is routed to a most appropriate telephony terminal or through a most appropriate network based on whether the mobile terminal is proximate to the docking station.

30. The method of claim 28 wherein the docking and undocking indicia are received from a wireline switch, which is coupled to the docking station.

31. The method of claim 28 wherein the docking and undocking indicia are received from the docking station over a packet network.

32. The method of claim 28 further comprising routing the incoming call to the mobile terminal through the docking station via a wireline switch coupled to the docking station when the mobile terminal is proximate to the docking station.

33. The method of claim 28 further comprising routing the incoming call to a wireline terminal coupled to the docking station or coupled to a telephony line connected to the docking station when the mobile terminal is proximate to the docking station.
